(19) United States
(12) Patent Application Publication
(10) Pub. No.: US 2026/0074616 A1
(43) Pub. Date: Mar. 12, 2026

(54) RESONANT POWER CONVERSION CIRCUIT WITH ASYMMETRIC CONTROL TO IMPROVE CONVERSION EFFICIENCY OF RESONANT POWER CONVERSION CIRCUIT AT LOW OUTPUT VOLTAGE

(71) Applicant: Richtek Technology Corporation, Zhubei City (TW)

(72) Inventors: Tzu-Chen LIN, Zhubei City (TW); Ta-Yung YANG, Taoyuan City (TW); Kuo-Chi LIU, Hsinchu City (TW); Yi-Min SHIU, Hsinchu City (TW)

(21) Appl. No.: 19/276,276

(22) Filed: Jul. 22, 2025

Related U.S. Application Data
(60) Provisional application No. 63/691,397, filed on Sep. 6, 2024.

(30) Foreign Application Priority Data
Jun. 25, 2025 (TW) 114123827

(51) Int. Cl. H02M 3/00; H02M 1/00; H02M 3/335

(52) U.S. Cl. CPC H02M 3/01; H02M 1/0058; H02M 3/33571

(57) ABSTRACT

A resonant power conversion circuit for converting an input voltage to an output voltage includes a transformer, a resonant capacitor, a high-side transistor, a low-side transistor, and a control circuit. The transformer includes a primary coil. The resonant capacitor and the primary coil are connected in series to a switch node. The high-side transistor provides the input voltage to the switch node, and the low-side transistor couples the switch node to the ground. In each switch cycle, the control circuit sequentially turns on the high-side transistor, turns on the low-side transistor, turns on the high-side transistor twice, turns on the low-side transistor twice, and turns off both the high-side transistor and the low-side transistor.

### CROSS REFERENCE TO RELATED APPLICATIONS

This application claims the benefit of U.S. Provisional Application No. 63/691,397, filed on Sep. 6, 2024, the entirety of which is incorporated by reference herein.

This application claims priority of Taiwan Patent Application No. 114123827, filed on Jun. 25, 2025, the entirety of which is incorporated by reference herein.

### BACKGROUND OF THE INVENTION

### Field of the Invention

The disclosure is generally related to a resonant power conversion circuit, and more particularly it is related to a resonant power conversion circuit with asymmetric control, thereby improving the conversion efficiency of the resonant power conversion circuit at low output voltages.

### Description of the Related Art

Portable electronic devices are undergoing continuous development, especially in the field of power conversion circuits, with the trend being towards high efficiency, high power density, high reliability, and low costs. Resonant power conversion circuits (such as LLC resonant power conversion circuits) have certain advantages, including the capability to achieve zero-voltage switching (ZVS) on the primary side and zero-current switching (ZCS) of the rectification diode on the secondary side within the full load range. Further advantages include using frequency control to make sure that the duty cycles of the high-side transistor and the low-side transistor are both 50%; ensuring that no output inductor is required; and adapting lower voltage transistors on the secondary side to reduce costs and improve efficiency. As a result, they have increasingly been used in DC voltage converters in recent years.

Since the duty cycles of the high-side and low-side transistors of traditional resonant power conversion circuits are both 50%, the operating frequency of resonant power conversion circuits needs to be increased in order to reduce the output voltage. However, high operating frequency results in significant switching power loss, thereby reducing the conversion efficiency when the resonant power conversion circuit generates a low output voltage. In order to make the resonant power conversion circuit generate a wider range of output voltages, it is necessary to optimize the control method of the resonant power conversion circuit.

### BRIEF SUMMARY OF THE INVENTION

Resonant power conversion circuits have been proposed herein, which reduces the operating frequency of the resonant power conversion circuit at low output voltages by asymmetrically turning on the high-side transistor and the low-side transistor and adding a skip period to improve the conversion efficiency of the resonant power conversion circuit at low output voltages, thereby expanding the range of the output voltage of the resonant power conversion circuit.

In an embodiment, a resonant power conversion circuit for converting an input voltage into an output voltage is provided. The resonant power conversion circuit comprises a transformer, a resonant capacitor, a high-side transistor, a low-side transistor, and a control circuit. The transformer comprises a primary coil and a secondary coil, wherein the primary coil is coupled between a switch node and a resonant node. The resonant capacitor is coupled between the resonant node and a ground. The high-side transistor provides the input voltage to the switch node based on a high-side driving signal. The low-side transistor couples the switch node to the ground based on a low-side driving signal. The control circuit generates the high-side driving signal and the low-side driving signal in each switching period based on a resonant current flowing through the resonant capacitor and the output voltage. Each switching period comprises the following periods. In a first driving period, the control circuit turns on the high-side transistor and turns off the low-side transistor. In a second driving period after the first driving period, the control circuit turns off the high-side transistor and turns on the low-side transistor. In a third driving period after the second driving period, the control circuit turns on the high-side transistor and turns off the low-side transistor. In a fourth driving period after the third driving period, the control circuit turns off the high-side transistor and turns on the low-side transistor. In a fifth driving period after the fourth driving period, the control circuit turns off both the high-side transistor and the low-side transistor. In response to the resonant current dropping to zero in the second driving period and a predetermined period having elapsed, the control circuit turns off the low-side transistor.

According to an embodiment of the present invention, the fifth driving period of one switching period ends, the control circuit immediately executes the first driving period of another switching period. There is a first dead time between the first driving period and the second driving period. There is a second dead time between the second driving period and the third driving period. There is a third dead time between the third driving period and the fourth driving period.

According to an embodiment of the present invention, the resonant power conversion circuit further comprises a current detection circuit and a feedback circuit. The current detection circuit detects the resonant current to generate a current detection signal. The feedback circuit generates a feedback signal based on the output voltage. The control circuit superimposes the current detection signal to a slope compensation signal to generate a superposition signal and integrates the superposition signal to generate a first integral signal. The control circuit further full-wave rectifies the first integral signal to generate a full-wave rectification signal. The control circuit integrates the feedback signal to generate a second integral signal and compares the full-wave rectification signal with the second integral signal to generate the high-side driving signal and the low-side driving signal.

According to an embodiment of the present invention, in response to the full-wave rectification signal dropping to not exceeding the second integral signal during the first driving period, the control circuit turns off the high-side transistor. In response to the full-wave rectification signal dropping to not exceeding the second integral signal during the third driving period, the control circuit turns off the high-side transistor.

According to an embodiment of the present invention, in response to the current detection signal dropping to zero during the second driving period and the predetermined period having elapsed, the control circuit turns off the low-side transistor.

According to an embodiment of the present invention, in response to the current detection signal dropping to zero during the fourth driving period, the control circuit turns off the low-side transistor.

According to an embodiment of the present invention, a resonant period is determined by the resonant capacitor. The predetermined period is less than one-half of the resonant period.

According to an embodiment of the present invention, a length of the fifth driving period is a fixed value.

According to another embodiment of the present invention, a length of the fifth driving period is determined by the output power of the output voltage. When the output power decreases, the length of the fifth driving period increases. When the output power increases, the length of the fifth driving period decreases.

In another embodiment, a resonant power conversion circuit for converting an input voltage to an output voltage is provided. The resonant power conversion circuit comprises a transformer, a resonant capacitor, a high-side transistor, a low-side transistor, and a control circuit. The transformer comprises a primary coil and a secondary coil, wherein the primary coil is coupled between a switch node and a resonant node. The resonant capacitor is coupled between the resonant node and a ground. The high-side transistor provides the input voltage to the switch node based on a high-side driving signal. The low-side transistor couples the switch node to the ground based on a low-side driving signal. The control circuit generates the high-side driving signal and the low-side driving signal in each switching period based on a resonant current flowing through the resonant capacitor and the output voltage. Each switching period comprises the following periods. In a first driving period, the control circuit turns off the high-side transistor and turns on the low-side transistor. In a second driving period after the first driving period, the control circuit turns on the high-side transistor and turns off the low-side transistor. In a third driving period after the second driving period, the control circuit turns off the high-side transistor and turns on the low-side transistor. A length of the first driving period is a fixed value, so that the high-side transistor is turned on under zero-voltage switching during the second driving period to reduce a frequency for driving the resonant power conversion circuit.

According to an embodiment of the present invention, the fixed value is less than one-half of a resonant period. The resonant period is determined by the resonant capacitor.

According to an embodiment of the present invention, when the third driving period of one switching period ends, the control circuit immediately executes the first driving period of another switching period. A first dead time is between the first driving period and the second driving period.

According to an embodiment of the present invention, each switching period comprises a fourth driving period. The fourth driving period is between the second driving period and the third driving period. The control circuit turns off the high-side transistor and turns on the low-side transistor during the fourth driving period. A second dead time is between the second driving period and the fourth driving period.

According to an embodiment of the present invention, the resonant power conversion circuit further comprises a current detection circuit and a feedback circuit. The current detection circuit detects the resonant current to generate a current detection signal. The feedback circuit generates a feedback signal based on the output voltage. The control circuit superimposes the current detection signal to a slope compensation signal to generate a superposition signal and integrates the superposition signal to generate a first integral signal.

The control circuit further full-wave rectifies the first integral signal to generate a full-wave rectification signal. The control circuit integrates the feedback signal to generate a second integral signal and compares the full-wave rectification signal with the second integral signal to generate the high-side driving signal and the low-side driving signal.

According to an embodiment of the present invention, in response to the full-wave rectification signal dropping to not exceeding the second integral signal during the second driving period, the control circuit turns off the high-side transistor. In response to the current detection signal dropping to zero during the fourth driving period, the control circuit turns off the low-side transistor.

According to an embodiment of the present invention, a length of the third driving period is a fixed value.

According to another embodiment of the present invention, a length of the third driving period is determined by the output power of the output voltage. When the output power of the output voltage decreases, the length of the third driving period increases. When the output power of the output voltage increases, the length of the third driving period decreases.

In yet another embodiment, a resonant power conversion circuit for converting an input voltage to an output voltage is provided. The resonant power conversion circuit comprises a transformer, a resonant capacitor, a high-side transistor, a low-side transistor, and a control circuit. The transformer comprises a primary coil and a secondary coil, wherein the primary coil is coupled between a switch node and a resonant node. The resonant capacitor is coupled between the resonant node and a ground. The high-side transistor provides the input voltage to the switch node based on a high-side driving signal. The low-side transistor couples the switch node to the ground based on a low-side driving signal. The control circuit generates the high-side driving signal and the low-side driving signal in each switching period based on a resonant current flowing through the resonant capacitor and the output voltage. Each switching period comprises the following periods. In a first driving period, the control circuit turns off the high-side transistor and turns on the low-side transistor.

In a second driving period after the first driving period, the control circuit turns on the high-side transistor and turns off the low-side transistor. In a third driving period after the second driving period, the control circuit turns off the high-side transistor and turns on the low-side transistor. In a fourth driving period after the third driving period, the control circuit turns on the high-side transistor and turns off the low-side transistor. In a fifth driving period after the fourth driving period, the control circuit turns off both the high-side transistor and the low-side transistor. A length of the first driving period is a first fixed value. The first fixed value is less than one-half of a resonant period. The resonant period is determined by the resonant capacitor.

According to an embodiment of the present invention, when the fifth driving period of one switching period ends, the control circuit immediately executes the first driving period of another switching period. A first dead time is between the first driving period and the second driving period. A second dead time is between the second driving period and the third driving period. A third dead time is between the third driving period and the fourth driving period.

According to an embodiment of the present invention, the resonant power conversion circuit further comprises a current detection circuit and a feedback circuit. The current detection circuit detects the resonant current to generate a current detection signal. The feedback circuit generates a feedback signal based on the output voltage. The control circuit superimposes the current detection signal to a slope compensation signal to generate a superposition signal and integrates the superposition signal to generate a first integral signal. The control circuit further full-wave rectifies the first integral signal to generate a full-wave rectification signal. The control circuit integrates the feedback signal to generate a second integral signal and compares the full-wave rectification signal with the second integral signal to generate the high-side driving signal and the low-side driving signal.

According to an embodiment of the present invention, in response to the full-wave rectification signal dropping to not exceeding the second integral signal during the second driving period, the control circuit turns off the high-side transistor. In response to the full-wave rectification signal dropping to not exceeding the second integral signal during the fourth driving period, the control circuit turns off the high-side transistor.

According to an embodiment of the present invention, in response to the current detection signal dropping to zero during the third driving period and a predetermined period having elapsed, the control circuit turns off the low-side transistor. The predetermined period is less than one-half of the resonant period.

According to an embodiment of the present invention, a length of the fifth driving period is a second fixed value.

According to another embodiment of the present invention, a length of the fifth driving period is determined by the output power of the output voltage. When the output power decreases, the length of the fifth driving period increases. When the output power increases, the length of the fifth driving period decreases.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a block diagram of a resonant power conversion circuit in accordance with an embodiment of the present invention;

FIG. 2 shows a waveform diagram of a resonant power conversion circuit in accordance with an embodiment of the present invention;

FIG. 3 shows a block diagram of a resonant power conversion circuit in accordance with another embodiment of the present invention;

FIG. 4 shows a waveform diagram of a resonant power conversion circuit in accordance with another embodiment of the present invention;

FIG. 5 shows a block diagram of a resonant power conversion circuit in accordance with another embodiment of the present invention;

FIG. 6 shows a block diagram of a resonant power conversion circuit in accordance with another embodiment of the present invention; and

FIG. 7 shows a waveform diagram of a resonant power conversion circuit in accordance with another embodiment of the present invention.

### DETAILED DESCRIPTION OF THE INVENTION

The following description is made for the purpose of illustrating the general principles of the disclosure and should not be taken in a limiting sense. The scope of the disclosure is determined by reference to the appended claims.

In the following detailed description, for purposes of explanation, numerous specific details and embodiments are set forth in order to provide a thorough understanding of the present disclosure. The use of like and/or corresponding numerals in the drawings of different embodiments does not suggest any correlation between different embodiments.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In addition, in this specification, relative spatial expressions are used. For example, “lower”, “bottom”, “higher” or “top” are used to describe the position of one element relative to another. It should be appreciated that if a device is flipped upside down, an element that is “lower” will become an element that is “higher”.

It should be understood that, although the terms first, second, third etc. may be used herein to describe various elements, components, regions, layers, portions and/or sections, these elements, components, regions, layers, portions and/or sections should not be limited by these terms. These terms are only used to distinguish one element, component, region, layer, portion or section from another element, component, region, layer or section. Thus, a first element, component, region, layer, portion or section in the specification could be termed a second element, component, region, layer, portion or section in the claims without departing from the teachings of the present disclosure.

It should be understood that this description of the exemplary embodiments is intended to be read in connection with the accompanying drawings, which are to be considered part of the entire written description. The drawings are not drawn to scale. In addition, structures and devices are shown schematically in order to simplify the drawing.

The terms “approximately”, “about” and “substantially” typically mean a value is within a range of +/−20% of the stated value, more typically a range of +/−10%, +/−5%, +/−3%, +/−2%, +/−1% or +/−0.5% of the stated value. The stated value of the present disclosure is an approximate value. Even there is no specific description, the stated value still includes the meaning of “approximately”, “about” or “substantially”.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In the drawings, similar elements and/or features may have the same reference number. Various components of the same type can be distinguished by adding letters or numbers after the component symbol to distinguish similar components and/or similar features.

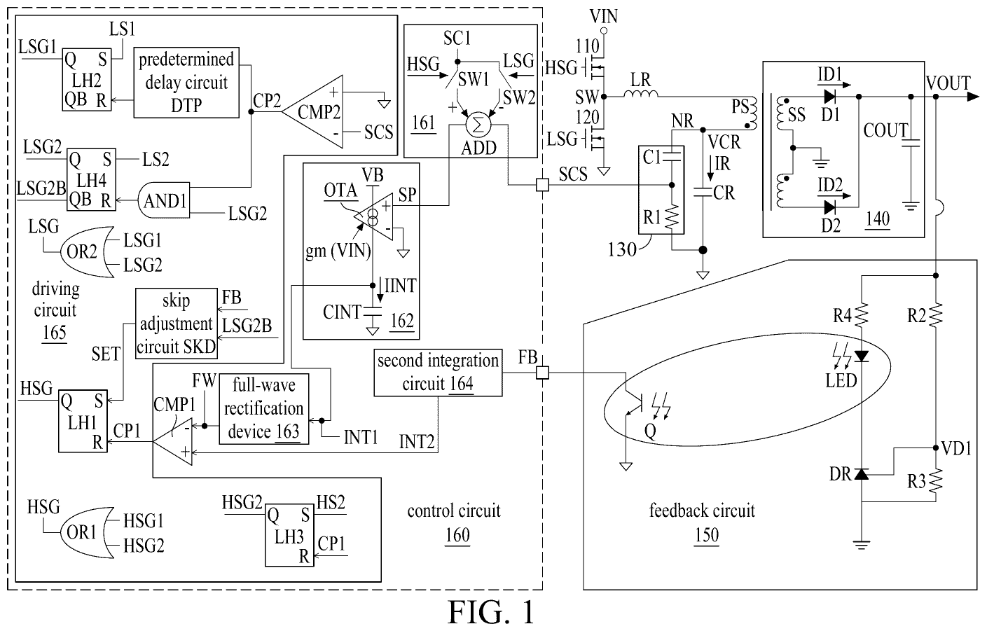

FIG. 1 shows a block diagram of a resonant power conversion circuit in accordance with an embodiment of the present invention. As shown in FIG. 1, the resonant power conversion circuit 100 includes a transformer TM, a resonant inductor LR, a resonant capacitor CR, a high-side transistor 110, a low-side transistor 120, a current detection circuit 130, a rectification circuit 140, a feedback circuit 150, and a control circuit 160.

The transformer TM includes a primary coil PS and a secondary coil SS, where the primary coil PS is coupled to the resonant node NR. The resonant inductor LR is coupled between the switch node SW and the primary coil PS, and the resonant capacitor CR is coupled to the resonant node NR and the ground, and the resonant node NR generates a resonant voltage VCR. According to an embodiment of the present invention, the resonant inductor LR may be replaced by the leakage inductance of the primary coil PS of the transformer TM.

In other words, the primary coil PS may be coupled between the switch node SW and the resonant node NR. According to one embodiment of the present invention, the resonant power conversion circuit 100 may be an LLC resonant power conversion circuit.

The high-side gate driving signal HSG turns on and off the high-side transistor 110 to provide the input voltage VIN to the switch node SW. The low-side gate driving signal LSG turns on and off the low-side transistor 120 to couple the switch node SW to the ground. The current detection circuit 130 is coupled to the resonant node NR to detect the resonant current IR flowing through the resonant capacitor CR to generate the current detection signal SCS.

The current detection circuit 130 includes a first capacitor C1 and a first resistor R1. The first capacitor C1 is coupled to the resonant node NR, and the first resistor R1 is coupled between the first capacitor C1 and the ground, where a current detection signal SCS is generated between the first capacitor C1 and the first resistor R1. In other words, the current detection signal SCS is a voltage across the first resistor R1, and the current detection signal SCS is configured to represent the resonant current IR.

The rectification circuit 140 is coupled to the secondary coil SS to convert the energy of the secondary line source SS into an output voltage VOUT. In other words, the rectification circuit 140 is configured to convert the current flowing through the secondary coil SS into an output voltage VOUT. As shown in FIG. 1, the rectification circuit 140 includes a first rectification element D1, a second rectification element D2, and an output capacitor COUT.

The first rectification element D1 and the second rectification element D2 respectively generate the first rectification current ID1 and the second rectification current ID2 to more efficiently charge the output capacitor COUT by the current flowing through the secondary coil SS, and then generate the output voltage VOUT. According to other embodiments of the present invention, the first rectification element D1 and the second rectification element D2 may be replaced with electronic components with low on-resistance to further improve the conversion efficiency.

The feedback circuit 150 generates a feedback signal FB based on the output voltage VOUT. As shown in FIG. 1, the feedback circuit 150 includes a second resistor R2, a third resistor R3, a voltage regulation element DR, an optocoupler PD, and a fourth resistor R4. The second resistor R2 and the third resistor R3 are configured to divide the output voltage VOUT to generate the first voltage divider voltage VD1. The voltage regulation element DR generates a current flowing through the diode LED of the optocoupler PD to emit light based on the first voltage divided voltage VD1, and turns on the transistor Q of the optocoupler PD through optical coupling, thereby generating a feedback signal FB.

The fourth resistor R4 is configured to limit the current flowing through the diode LED. According to an embodiment of the present invention, the voltage regulation element DR may be TL431. According to one embodiment of the present invention, when the output voltage VOUT increases, the feedback signal FB decreases accordingly. According to another embodiment of the present invention, when the output voltage VOUT drops, the feedback signal FB increases accordingly. According to an embodiment of the present invention, when the output power of the output voltage VOUT increases, the feedback signal FB increases accordingly. According to another embodiment of the present invention, when the output power of the output voltage VOUT decreases, the feedback signal FB decreases accordingly.

The control circuit 160 generates the high-side gate driving signal HSG and the low-side gate driving signal LSG based on the current detection signal SCS and the feedback signal FB. As shown in FIG. 1, the control circuit 160 includes a first superposition circuit 161, a first integration circuit 162, a full-wave rectification device 163, a second integration circuit 164, a first comparator CMP1, and a driving circuit 165.

The first superposition circuit 161 is configured to superimpose the current detection signal SCS on the first slope compensation signal SC1 to generate the superposition signal SP. According to some embodiments of the invention, the first slope compensation signal SC1 is configured to eliminate the negative impact of the right half-plane zero. According to an embodiment of the present invention, the first slope compensation signal SC1 is a sawtooth wave. In other words, the first slope compensation signal SC1 is a result obtained by integrating a constant against time. As shown in FIG. 1, the first superposition circuit 161 includes a first switch SW1, a second switch SW2, and an addition circuit ADD.

According to one embodiment of the present invention, when the high-side gate driving signal HSG conducts the high-side transistor 110, the first switch SW1 is turned on, and the addition circuit ADD adds the current detection signal SCS to the first slope compensation signal SC1, thereby generating the superimposed signal SP. According to another embodiment of the present invention, when the low-side gate driving signal LSG turns on the low-side transistor 120, the second switch SW2 is turned on, and the addition circuit ADD subtracts the current detection signal SCS by the first slope compensation signal SC1 to generate the superimposed signal SP.

The first integration circuit 162 is configured to integrate the superposition signal SP to generate the first integral signal INT1. As shown in FIG. 1, the first integration circuit 162 includes a transconductance amplifier OTA and an integration capacitor CINT. The transconductance amplifier OTA is powered by the bias voltage VB to generate an integral current IINT based on the superposition signal SP. The integral current IINT charges the integral capacitor CINT to generate the first integral signal INT1. According to an embodiment of the present invention, the transconductance gm generated by the transconductance amplifier OTA is proportional to the input voltage VIN.

The full-wave rectification device 163 is configured to perform full-wave rectification on the first integral signal INT1 and generate a full-wave rectification signal FW. The second integration circuit 164 integrates the feedback signal FB to generate the second integral signal INT2. The first comparator CMP1 compares the full-wave rectification signal FW and the second integral signal INT2 to generate the first comparison signal CP1. According to one embodiment of the present invention, when the full-wave rectification signal FW exceeds the second integral signal INT2, the first comparison signal CP1 is disabled. According to another embodiment of the present invention, when the full-wave rectification signal FW does not exceed the second integral signal INT2, the comparison signal CP is enabled.

As shown in FIG. 1, the driving circuit 165 is configured to generate the high-side gate driving signal HSG and the low-side gate driving signal LSG, and includes a skip adjustment circuit SKD, the first latch LT1, the first OR gate OR1, the second latch LH2, the second OR gate OR2, the second comparator CMP2, the predetermined delay circuit DTP, the third latch LH3, the fourth latch LH4, and the first AND gate AND1.

The skip adjustment circuit SKD delays the skip period SK based on the rising edge of the second inverted low-side gate driving signal LSG2B to enable the set signal SET after the skip period SK. According to some embodiments of the present invention, the skip period SK of the skip adjustment circuit SKD is a fixed value. According to other embodiments of the present invention, the skip adjustment circuit SKD adjusts the length of the skip period SK based on the feedback signal FB. According to one embodiment of the present invention, when the output power of the output voltage VOUT increases, the feedback signal FB increases, and the skip adjustment circuit SKD shortens the skip period SK accordingly. According to another embodiment of the present invention, when the power of the output voltage VOUT decreases, the feedback signal FB decreases, and the skip adjustment circuit SKD extends the skip period SK accordingly.

The first latch LH1 enables the first high-side gate driving signal HSG1 based on the enabled set signal SET to enable the high-side gate driving signal HSG via the first OR gate OR1, thereby turning on the high-side transistor 110. According to an embodiment of the present invention, the rising edge of the first comparison signal CP1 resets the first latch LH1 to disable the first high-side gate driving signal HSG1, and disables the high-side gate driving signal HSG through the first OR gate OR1. In other words, when the full-wave rectification signal FW drops to no more than the second integral signal INT2, the first comparison signal CP1 generates a rising edge to disable the first high-side gate driving signal HSG1 and the high-side gate driving signal HSG, thereby turning off the high-side transistor 110.

After the high-side transistor 110 is turned off and a dead time has been delayed, the second latch LH2 enables the first low-side gate driving signal LSG1 based on the first low-side driving signal LS1 provided externally. The first low-side gate driving signal LSG1 being enabled enables the low-side gate driving signal LSG via the second OR gate OR2, thereby turning on the low-side transistor 120.

The second comparator CMP2 is configured to determine whether the current detection signal SCS drops to zero to generate the second comparison signal CP2. According to an embodiment of the present invention, when the current detection signal SCS is not less than zero, the second comparator CMP2 enables the second comparison signal CP2. According to another embodiment of the present invention, when the current detection signal SCS is less than zero, the second comparator CMP2 disables the second comparison signal CP2.

According to one embodiment of the present invention, when the current detection signal SCS drops to zero, the predetermined delay circuit DTP resets the second latch LH2 with the predetermined period TP being delayed based on the second comparison signal CP2 being enabled, so as to turn off the low-side transistor 120. In other words, when the resonant current IR drops to zero and the predetermined period TP has been delayed by the predetermined delay circuit DTP, the first low-side gate driving signal LSG1 and the low-side gate driving signal LSG are disabled, so as to turn off the low-side transistor 120.

According to an embodiment of the present invention, the predetermined period TP delayed by the predetermined delay circuit DTP is a fixed value. According to some embodiments of the present invention, the predetermined period TP is slightly less than one-half of the resonant period, where the resonant period is the product of the resonant inductor LR and the resonant capacitor CR. According to an embodiment of the present invention, the predetermined period TP is about 70% of one-half of the resonant period.

When the first low-side gate driving signal LSG1 is disabled and a dead time has been delayed, the third latch LH3 enables the second high-side gate driving signal HSG2 based on the enabled second high-side driving signal HS2 provided externally, and enables the high-side gate driving signal HSG through the first OR gate OR1, thereby turning on the high-side transistor 110. According to an embodiment of the present invention, when the full-wave rectification signal FW drops to not exceeding the second integral signal INT2, the rising edge of the first comparison signal CP1 resets the third latch LH3 to disable the second high-side gate driving signal HSG2 and the high-side gate driving signal HSG2, thereby turning off the high-side transistor 110.

When the second high-side gate driving signal HSG2 is disabled and a dead time has been delayed, the fourth latch LH4 enables the second low-side gate driving signal LSG2 based on the enabled second low-side driving signal LS2 provided externally to turn on the low-side transistor 120 via the second OR gate OR2. When the second comparator CMP2 determines that the current detection signal SCS has dropped to zero, the first AND gate AND1 resets the third latch LH3 based on the enabled second comparison signal CP2 and the enabled second low-side gate driving signal LSG2 to reset the third latch LH3, thereby disabling the second low-side gate driving signal LSG2 and enabling the second inverted low-side gate driving signal LSG2B. Next, the skip adjustment circuit SKD delays the predetermined period TP based on the rising edge of the second inverted low-side gate driving signal LSG2B, and enables the set signal SET after the predetermined period TP.

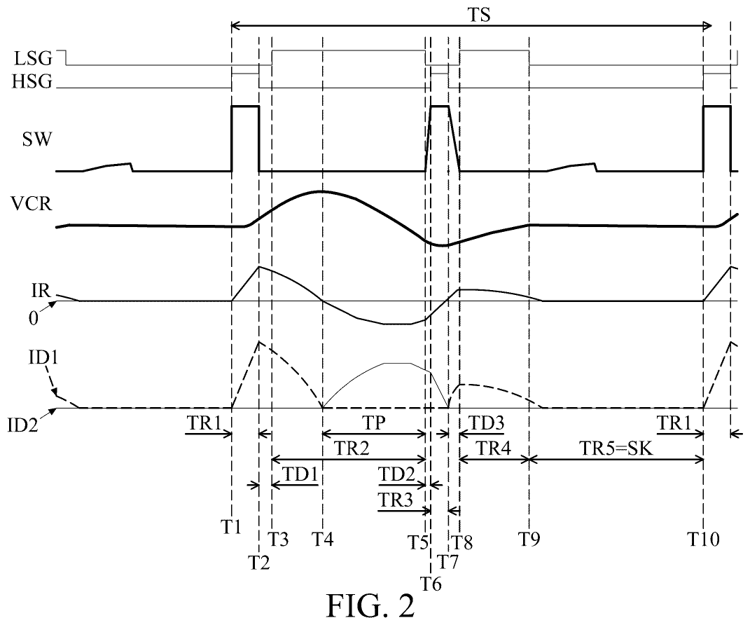

FIG. 2 shows a waveform diagram of a resonant power conversion circuit in accordance with an embodiment of the present invention. The following description of the waveform diagram in FIG. 2 will be combined with the resonant power conversion circuit 100 in FIG. 1 for detailed explanation. As shown in FIG. 2, each switching period TS includes a first driving period TR1, a first dead time TD1, a second driving period TR2, a second dead time TD2, a third driving period TR3, a third dead time TD3, a fourth driving period TR4, and a fifth driving period TR5.

According to some embodiments of the present invention, after the fifth driving period TR5 of each switching period TS, the control circuit 160 operates in the first driving period TR1 of another switching period TS. In the first driving period TR1, the first latch LH1 enables the first high-side gate driving signal HSG1 at the first time point T1 and enables the high-side gate driving signal HSG through the first OR gate OR1, thereby turning on the high-side transistor 110. Since the high-side transistor 110 is turned on during the first driving period TR1, the voltage of the switch node SW, the resonant voltage VCR, and the resonant current IR are all increased. In addition, the first rectification element D1 is turned on during the first driving period to generate the first rectification current ID1, thereby charging the output capacitor COUT to generate an output voltage VOUT.

According to one embodiment of the present invention, when the full-wave rectification signal FW drops to not exceeding the second integral signal INT2, the rising edge of the first comparison signal CP1 resets the first latch LH1 to disable the high-side gate driving signal HSG at the second time point T2, thereby turning off the high-side transistor 110. In the second driving period TR2 after the first dead time TD1, the second latch LH2 enables the first low-side gate driving signal LSG1 at the third time point T3 to enable the low-side gate driving signal LSG via the second OR gate OR2, thereby turning on the low-side transistor 120. According to some embodiments of the present invention, the length of the first dead time TD1 can be adjusted so that the low-side transistor 120 is turned on under zero-voltage switching at the third time point T3. In other words, in the second driving period TR2 from the third time point T3 to the fifth time point T5, the high-side transistor 110 is turned off and the low-side transistor 120 is turned on.

As shown in FIG. 2, the resonant current IR drops to zero at the fourth time point T4. According to some embodiments of the present invention, since the current detection signal SCS is configured to represent the resonant current IR, the second comparator CMP2 enables the second comparison signal CP2 to indicate that the resonant current IR drops to zero. In addition, the predetermined delay circuit DTP delays the predetermined period TP, so that the low-side transistor 120 is turned off at the fifth time point T5 after the resonant current IR drops to zero and the predetermined period TP has been delayed.

According to some embodiments of the present invention, since the low-side transistor 120 is turned off after the resonant current IR drops to zero and the predetermined period TP has been delayed during the second driving period TR2, the operating frequency of the resonant power conversion circuit 100 in FIG. 1 is reduced, thereby breaking through the limitation that the traditional resonant power conversion circuit needs to increase the operating frequency due to the low output voltage, and the conversion efficiency of the resonant power conversion circuit at the low output voltage is improved. According to some embodiments of the present invention, the predetermined period TP is slightly less than one-half of the resonant period, where the resonant period is the product of the resonant inductor LR and the resonant capacitor CR. According to an embodiment of the present invention, the predetermined period TP is about 70% of one-half of the resonant period.

After the low-side transistor 120 is turned off at the fifth time point T5 and the second dead time TD2 has been delayed, the third latch LH3 enables the second high-side gate driving signal HSG2 based on the second high-side driving signal HS2 being enabled at the sixth time point T6 to enable the high-side gate driving signal HSG through the first OR gate OR1, thereby turning on the high-side transistor 110. According to some embodiments of the present invention, the length of the second dead time TD2 can be adjusted so that the high-side transistor 110 is turned on under zero-voltage switching at the sixth time point T6. In other words, in the third driving period TR3 from the sixth time point T6 to the seventh time point T7, the high-side transistor 110 is turned on and the low-side transistor 120 is turned off.

When the control circuit 160 determines that the full-wave rectification signal FW drops to not exceeding the second integral signal INT2, the rising edge of the first comparison signal CP1 generated by the first comparator CMP1 resets the third latch LH3 to disable the second high-side gate driving signal HSG2 at the seventh time point T7 and to disable the high-side gate driving signal HSG through the first OR gate OR1, thereby turning off the high-side transistor 110.

After the high-side transistor 110 is turned off at the seventh time point T7 and the third dead time TD3 between the seventh time point T7 and the eighth time point T8 has been delayed, the fourth latch LH4 enables the second low-side gate driving signal LSG2 at the eighth time point T8 to disable the low-side gate driving signal LSG through the second OR gate OR2, thereby turning on the low-side transistor 120. In other words, in the fourth driving period TR4 from the eighth time point T8 to the ninth time point T9, the control circuit 160 disables the high-side gate driving signal HSG to turn off the high-side transistor 110, and enables the low-side gate driving signal LSG to turn on the low-side transistor 120.

According to some embodiments of the present invention, the length of the third dead time TD3 can be adjusted so that the low-side transistor 120 is turned on under zero-voltage switching at the eighth time point T8. According to some embodiments of the present invention, the first dead time TD1, the second dead time TD2, and the third dead time TD3 may be the same or different.

When the current detection signal SCS drops to zero (i.e., the resonant current IR drops to zero), the second comparator CMP2 enables the second comparison signal CP2. The first AND gate AND1 resets the third latch LH3 based on the enabled second comparison signal CP2 and the enabled second low-side gate driving signal LSG2 to disable the second low-side gate driving signal LSG2 and to disable the low-side gate driving signal LSG through the second OR gate OR2. In addition, the fourth latch LH4 being reset generates a rising edge on the second inverted low-side gate driving signal LSG2B, and the skip adjustment circuit SKD generates the fifth driving period TR5 based on the rising edge of the second inverted low-side gate driving signal LSG2B. In other words, the length of the fifth driving period TR5 is equal to the skip period SK generated by the skip adjustment circuit SKD.

In the fifth driving period TR5 from the ninth time point T9 to the tenth time point T10, the control circuit 160 simultaneously disables the high-side gate driving signal HSG and the low-side gate driving signal LSG to simultaneously turn off the high-side transistor 110 and the low-side transistor 120. According to some embodiments of the present invention, the length of the fifth driving period TR5 may be a fixed value. According to some embodiments of the present invention, the skip adjustment circuit SKD may adjust the length of the fifth driving period TR5 based on the feedback signal FB.

According to one embodiment of the present invention, when the feedback signal FB increases, it means that the output power of the output voltage VOUT increases, so the skip adjustment circuit SKD decreases the length of the fifth driving period TR5. According to another embodiment of the present invention, when the feedback signal FB decreases, it means that the output power of the output voltage VOUT decreases, and therefore the skip adjustment circuit SKD increases the length of the fifth driving period TR5.

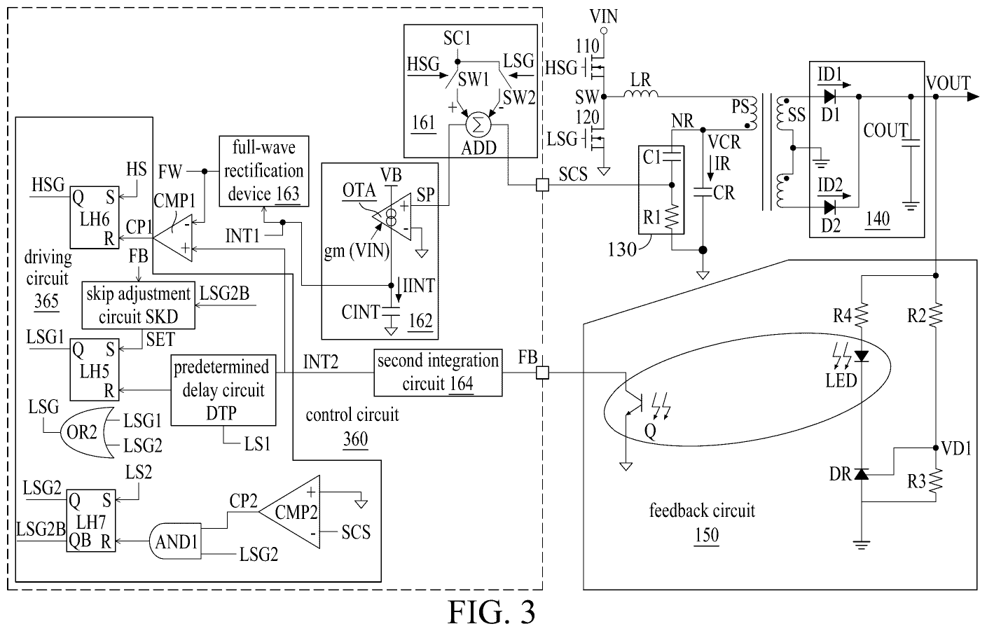

FIG. 3 shows a block diagram of a resonant power conversion circuit in accordance with another embodiment of the present invention. Compared with the resonant power conversion circuit 300 of FIG. 3 with the resonant power conversion circuit 100 of FIG. 1, the driving circuit 165 of the control circuit 160 of FIG. 1 is replaced by the driving circuit 365 of the control circuit 360. As shown in FIG. 3, the driving circuit 365 includes a skip adjustment circuit SKD, a fifth latch LH5, a second OR gate OR2, a predetermined delay circuit DTP, a sixth latch LH6, a seventh latch LH7, a second comparator CMP2, and a first AND gate AND1.

The skip adjustment circuit SKD starts counting the skip period SK based on the rising edge of the second inverted low-side gate driving signal LSG2B, and enables the set signal SET when the skip period SK is reached. According to some embodiments of the present invention, the skip period SK of the skip adjustment circuit SKD is a fixed value. According to other embodiments of the present invention, the skip adjustment circuit SKD adjusts the length of the skip period SK based on the feedback signal FB.

In other words, the skip adjustment circuit SKD can adjust the length of the skip period SK based on the power of the output voltage VOUT. The fifth latch LH5 enables the first low-side gate driving signal LSG1 based on the enabled set signal SET. In addition, the enabled first low-side gate driving signal LSG1 enables the low-side gate driving signal LSG via the second OR gate OR2, thereby turning on the low-side transistor 120.

The first low-side driving signal LS1 provided externally triggers the predetermined delay circuit DTP to delay the predetermined period TP to reset the fifth latch LH5, thereby disabling the first low-side gate driving signal LSG1. In other words, the enable time of the first low-side gate driving signal LSG1 is the predetermined period TP. When the first low-side gate driving signal LSG1 is disabled and a dead time has elapsed, the sixth latch LH6 enables the high-side gate driving signal HSG based on the externally-provided high-side driving signal HS, thereby turning on the high-side transistor 110. When the full-wave rectification signal FW drops to not exceeding the second integral signal INT2, the rising edge of the first comparison signal CP1 resets the sixth latch LH6, thereby disabling the high-side gate driving signal HSG to turn off the high-side transistor 110.

After the high-side gate driving signal HSG is disabled and a dead time has elapsed, the seventh latch LH7 enables the second low-side gate driving signal LSG2 based on the externally-provided second low-side driving signal LS2. In addition, the second low-side gate driving signal LSG2 being enabled enables the low-side gate driving signal LSG via the second OR gate OR2, thereby turning on the low-side transistor 120.

When the resonant current IR drops to zero, the second comparator CMP2 enables the second comparison signal CP2. The first AND gate AND1 resets the seventh latch LH7 based on the enabled second comparison signal CP2 and the enabled second low-side gate driving signal LSG2, thereby disabling the low-side gate driving signal LSG and generating a rising edge on the second inverted low-side gate driving signal LSG2B. Next, the rising edge of the second inverted low-side gate driving signal LSG2B triggers the skip adjustment circuit SKD counts the skip period SK.

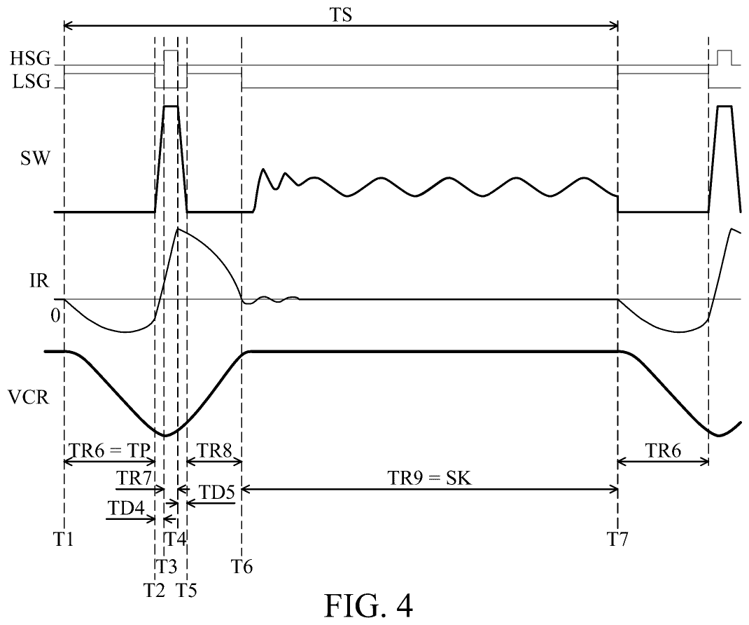

FIG. 4 shows a waveform diagram of a resonant power conversion circuit in accordance with another embodiment of the present invention. The following description of the waveform diagram in FIG. 4 will be combined with the resonant power conversion circuit 300 in FIG. 3 for detailed explanation. In the switching period TS, the control circuit 360 turns on the low-side transistor 120 at the first time point T1, and turns off the low-side transistor 120 at the second time point T2, where the length of the sixth driving period TR6 is determined by the predetermined period TP of the predetermined delay circuit DTP in FIG. 3.

In other words, the on-time of the low-side transistor 120 during the sixth driving period TR6 is a fixed value. That is, the on-time of the low-side transistor 120 during the sixth driving period TR6 is a fixed on-time. According to some embodiments of the present invention, the predetermined period TP is slightly less than one-half of the resonant period, where the resonant period is the product of the resonant inductor LR and the resonant capacitor CR. According to an embodiment of the present invention, the predetermined period TP is about 70% of one-half of the resonant period.

Then, the control circuit 360 turns on the high-side transistor 110 at the third time point T3. According to some embodiments of the present invention, the length of the fourth dead time TD4 of the second time point T2 to the third time point T3 may be adjusted to turn on the high-side transistor 110 under zero-voltage switching at the third time point T3. When the full-wave rectification signal FW drops to not exceeding the second integral signal INT2, the control circuit 360 turns off the high-side transistor 110 at the fourth time point T4. In other words, the length of the seventh driving period TR7 is determined by the control circuit of the resonant power conversion circuit 300 rather than a fixed on-time.

The control circuit 360 then turns on the low-side transistor 120 at the fifth time point T5. According to some embodiments of the present invention, the length of the fifth dead time TD5 from the fourth time point T4 to the fifth time point T5 may be controlled to turn on the low-side transistor 120 under zero-voltage switching at the fifth time point T5. When the resonant current IR drops to zero, the control circuit 360 turns off the low-side transistor 120 at the sixth time point T6. In other words, the length of the eighth driving period TR8 from the fifth time point T5 to the sixth time point T6 is determined by the control circuit of the resonant power conversion circuit 300.

In the ninth driving period TR9 from the sixth time point T6 to the seventh time point T7, the control circuit 360 turns off the high-side transistor 110 and the low-side transistor 120 at the same time, and the length of the ninth driving period TR9 is the skip period SK counted by the skip adjustment circuit SKD. According to some embodiments of the present invention, the ninth driving period TR9 of one switching period TS is followed by the sixth driving period TR6 of another switching period TS.

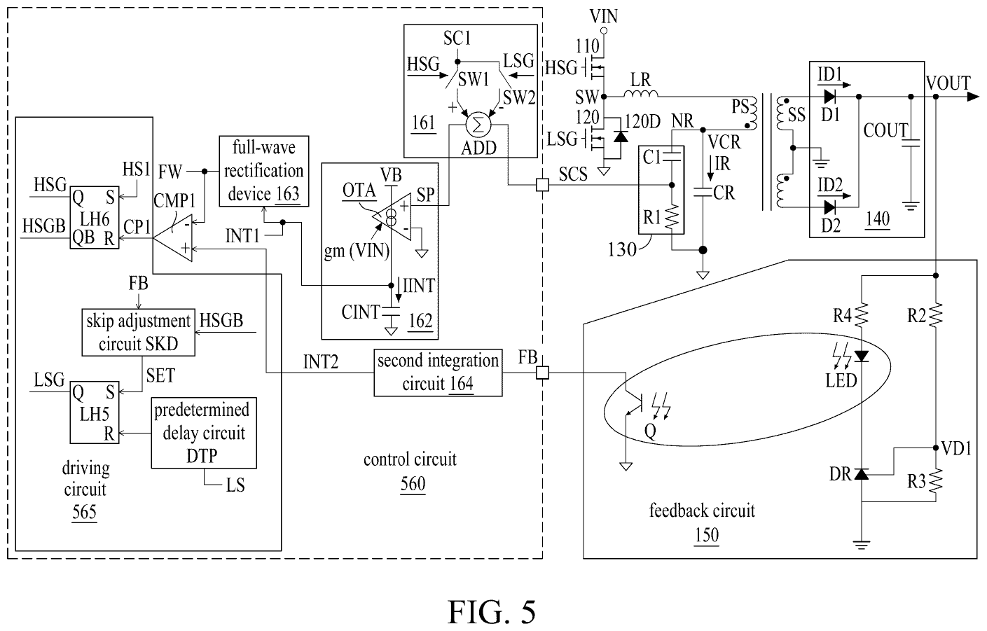

According to some embodiments of the present invention, since the sixth driving period TR6 is a fixed value and the high-side transistor 110 and the low-side transistor 120 are turns off simultaneously during the ninth driving period TR9, it helps to reduce the operating frequency of the resonant power conversion circuit 300, so as to improve the conversion efficiency of the resonant power conversion circuit at a low output voltage. FIG. 5 shows a block diagram of a resonant power conversion circuit in accordance with another embodiment of the present invention. Compared the resonant power conversion circuit 500 of FIG. 5 to the resonant power conversion circuit 300 of FIG. 3, the driving circuit 565 of the control circuit 560 omits the second OR gate OR2, the seventh latch LH7, the second comparator CMP2, and the first AND gate AND1. In addition, the skip adjustment circuit SKD of the driving circuit 565 is triggered by the rising edge of the inverted high-side gate driving signal HSGB generated by the sixth latch LH6, and the fifth latch LH5 directly generates the low-side gate driving signal LSG. The low-side driving signal LS triggers the predetermined delay circuit DTP to delay the predetermined period TP, thereby determining the on-time of the low-side transistor 120.

According to some embodiments of the present invention, the resonant power conversion circuit 500 sequentially turns on the low-side transistor 120, turns on the high-side transistor 110, and the low-side transistor 120, and turns off the high-side transistor 110 and the low-side transistor simultaneously in one switching period TS. In other words, the low-side gate driving signal LSG is disabled in the eighth driving period TR8 of FIG. 4, and the ninth driving period TR9 is from the fourth time point T4 to the seventh time point T7. That is, after the end of the seventh driving period TR7, the ninth driving period TR9 is immediately followed.

According to some embodiments of the present invention, when the high-side transistor 110 is turned off at the fourth time point T4 and then directly enters the ninth driving period TR9 to simultaneously turn off the high-side transistor 110 and the low-side transistor 120, the resonant current IR during the period from the fourth time point T4 to the sixth time point T6 is still greater than zero, so as to turn on the low-side parasitic diode 120D of the low-side transistor 120. According to some embodiments of the present invention, since the resonant power conversion circuit 500 of FIG. 5 turns on the low-side parasitic diode 120D during the period from the fourth time point T4 to the sixth time point T6, the resonant power conversion circuit 300 of FIG. 3 has a higher conversion efficiency than the resonant power conversion circuit 500 of FIG. 5.

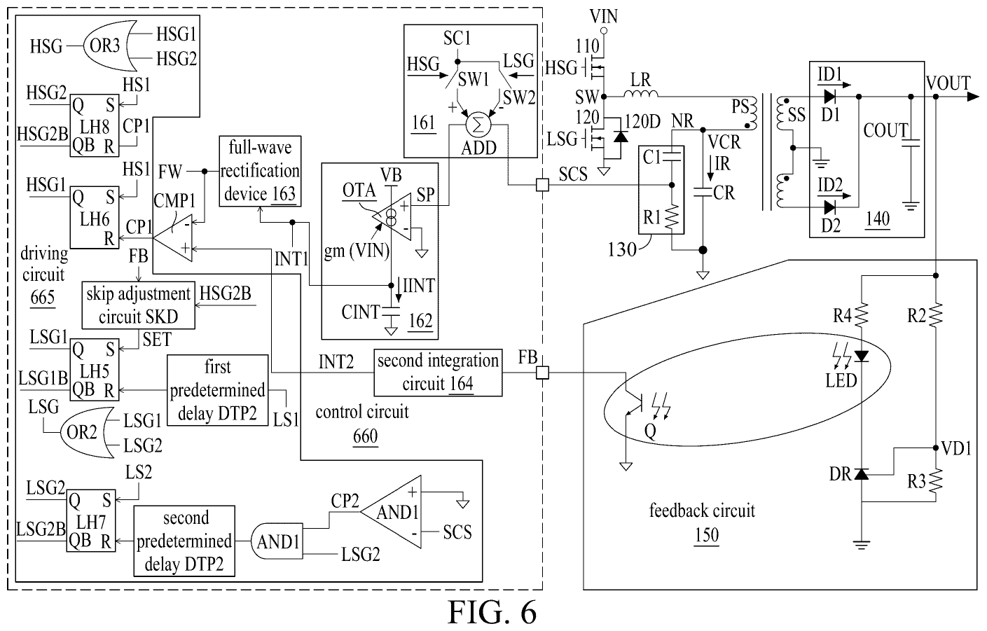

FIG. 6 shows a block diagram of a resonant power conversion circuit in accordance with another embodiment of the present invention. Compared the resonant power conversion circuit 600 in FIG. 6 to the resonant power conversion circuit 300 in FIG. 3, the driving circuit 665 of the control circuit 660 further includes a first predetermined delay circuit DTP1, a second predetermined delay circuit DTP2, a third OR gate OR3, and an eighth latch LH8, where the first predetermined delay circuit DTP1 replaces the predetermined delay circuit DTP of FIG. 3, and the second predetermined delay circuit DTP2 is located between the first AND gate AND1 and the seventh latch LH7.

After the skip adjustment circuit SKD counts the skip period SK, the set signal SET is enabled. According to some embodiments of the present invention, the skip period SK may be a fixed value, or the skip adjustment circuit SKD may adjust the length of the skip period SK based on the feedback signal FB. The fifth latch LH5 enables the first low-side gate driving signal LSG1 based on the set signal SET being enabled. In addition, the first low-side gate driving signal LSG1 being enabled enables the low-side gate driving signal LSG via the second OR gate OR2, thereby turning on the low-side transistor 120.

The first low-side driving signal LS1 provided externally triggers the first predetermined delay circuit DTP1 to reset the fourth latch LH4 with delay the first predetermined period TP1 being delayed, thereby disabling the first low-side gate driving signal LSG1. In other words, the enable time of the first low-side gate driving signal LSG1 is the first predetermined period TP1. According to some embodiments of the present invention, the first predetermined period TP1 is slightly less than one-half of the resonant period, where the resonant period is the product of the resonant inductor LR and the resonant capacitor CR. According to an embodiment of the present invention, the first predetermined period TP1 is about 70% of one-half of the resonant period.

When the first low-side gate driving signal LSG1 is disabled and a dead time has elapsed, the sixth latch LH6 enables the first high-side gate driving signal HSG1 based on the first high-side driving signal HS1 provided externally, and enables the high-side gate driving signal HSG via the third OR gate OR3, thereby turning on the high-side transistor 110. When the full-wave rectification signal FW drops to not exceeding the second integral signal INT2, the rising edge of the first comparison signal CP1 resets the sixth latch LH6, thereby disabling the first high-side gate driving signal HSG1 and the high-side gate driving signal HSG and turning off the high-side transistor 110.

After the high-side gate driving signal HSG is disabled and a dead time has elapsed, the seventh latch LH7 enables the second low-side gate driving signal LSG2 based on the externally-provided second low-side driving signal LS2. In addition, the second low-side gate driving signal LSG2 being enabled enables the low-side gate driving signal LSG via the second OR gate OR2, thereby turning on the low-side transistor 120.

When the resonant current IR drops to zero, the second comparator CMP2 enables the second comparison signal CP2. The first AND gate AND1 triggers the second predetermined delay circuit DTP2 to delay the second predetermined period TP2 based on the second comparison signal CP2 being enabled and the second low-side gate driving signal LSG2 being enabled, so that the seventh latch LH7 is reset when the resonant current IR drops to zero and the second predetermined period TP2 has elapsed, thereby disabling the low-side gate driving signal LSG to turn off the low-side transistor 120.

According to some embodiments of the present invention, the second predetermined period TP2 is slightly less than one-half of the resonant period, where the resonant period is the product of the resonant inductor LR and the resonant capacitor CR. According to an embodiment of the present invention, the second predetermined period TP2 is about 70% of one-half of the resonant period. According to some embodiments of the invention, the first predetermined period TP1 and the second predetermined period TP2 may be the same or different.

After the low-side gate driving signal LSG is disabled and a dead time has elapsed, the eighth latch LH8 enables the second high-side gate driving signal HSG2 based on the externally-provided second high-side driving signal HS2 to enable the high-side gate driving signal HSG via the third OR gate OR3, thereby turning on the high-side transistor 110. When the full-wave rectification signal FW drops to not exceeding the second integral signal INT2, the rising edge of the first comparison signal CP1 resets the eighth latch LH8, thereby disabling the second high-side gate driving signal HSG2 and the high-side gate driving signal HSG to turn off the high-side transistor 110.

When the eighth latch LH8 is disabled, not only the second high-side gate driving signal HSG2 is disabled, but also a rising edge is generated at the second inverted high-side gate driving signal HSG2B. The rising edge of the second inverted high-side gate driving signal HSG2B triggers the skip adjustment circuit SKD to count the skip period SK to enable the first low-side gate driving signal LSG1, in which the high-side transistor 110 and the low-side transistor 120 are both turned off during the skip period SK.

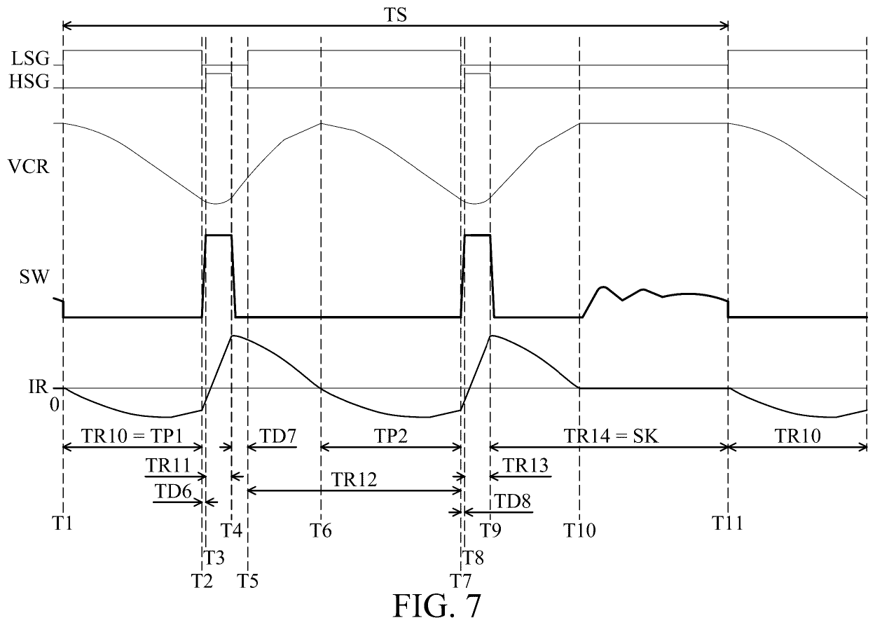

FIG. 7 shows a waveform diagram of a resonant power conversion circuit in accordance with another embodiment of the present invention. The following description of the waveform diagram in FIG. 7 will be combined with the resonant power conversion circuit 600 in FIG. 6 for detailed explanation. The tenth driving period TR10, the sixth dead time TD6, the eleventh driving period TR11, and the seventh dead time TD7 are the same as the sixth driving period TR6, the fourth dead time TD4, the seventh driving time TR7 and the fifth dead time TD5 in FIG. 4, which will not be repeated herein.

According to some embodiments of the present invention, the length of the tenth driving period TR10 is determined by the first predetermined delay circuit DTP1. In other words, the length of the tenth driving period TR10 is equal to the first predetermined period TP1 delayed by the first predetermined delay circuit DTP1.

In the twelfth driving period TR12 from the fifth time point T5 to the seventh time point T7, the seventh latch LH7 enables the second low-side gate driving signal LSG2 based on the second low-side driving signal LS2 being enabled, thereby turning on the low-side transistor 120. When the resonant current IR drops to zero at the sixth time point T6 and the second delayed set time TP2 has elapsed, the low-side transistor 120 is turned off at the seventh time point T7. In other words, the on-time of the low-side transistor 120 during the twelfth driving period TR 12 is a sum of the time required for the resonant current IR dropping to zero and the second predetermined period TP2.

According to some embodiments of the present invention, the length of the eighth dead time TD8 from the seventh time point T7 to the eighth time point T8 may be controlled so that the high-side transistor 110 is turned on under zero-voltage switching at the eighth time point T8. Next, the high-side transistor 110 is turned on during the thirteenth driving period TR13 from the eighth time point T8 to the ninth time point T9. When the full-wave rectification signal FW drops to not exceeding the second integral signal INT2, the rising edge of the first comparison signal CP1 disables the second high-side gate driving signal HSG2 and the high-side gate driving signal HSG to turn off the high-side transistor 110 at the ninth time point T9.

When the second high-side gate driving signal HSG2 is disabled, the rising edge of the second inverted high-side gate driving signal HSG2B triggers the skip adjustment circuit SKD to count the skip period SK. As shown in FIG. 7, the length of the fourteenth driving period TR14 from the ninth time point T9 to the eleventh time point T11 is equal to the skip period SK, and both the high-side transistor 110 and the low-side transistor 120 are turned off during the fourteenth driving period TR14.

According to some embodiments of the invention, the skip period SK may be a fixed value. According to other embodiments of the present invention, the skip adjustment circuit SKD may adjust the length of the skip period SK based on the output power of the output voltage VOUT. According to one embodiment of the present invention, when the output power of the output voltage VOUT increases, the skip adjustment circuit SKD shortens the length of the skip period SK. According to another embodiment of the present invention, when the output power of the output voltage VOUT decreases, the skip adjustment circuit SKD increases the length of the skip period SK.

As shown in FIG. 7, since the skip period SK is entered right after the high-side transistor 110 is turned off at the ninth time point T9, the resonant current IR between the ninth time point T9 and the tenth time point T10 exceeds zero, so that the low-side parasitic diode 120D is then turned on to cause power loss. According to some embodiments of the present invention, the low-side transistor 120 may be turned on again between the ninth time point T9 and the tenth time point T10, thereby reducing the power loss caused by the resonant current IR flowing through the low-side parasitic diode 120D, so as to further improve the conversion efficiency.

Resonant power conversion circuits have been proposed herein, which reduces the operating frequency of the resonant power conversion circuit at low output voltages by asymmetrically turning on the high-side transistor and the low-side transistor and adding a skip period to improve the conversion efficiency of the resonant power conversion circuit at low output voltages, thereby expanding the range of the output voltage of the resonant power conversion circuit.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A resonant power conversion circuit for converting an input voltage into an output voltage, comprising:
a transformer, comprising a primary coil and a secondary coil, wherein the primary coil is coupled between a switch node and a resonant node;
a resonant capacitor, coupled between the resonant node and a ground;
a high-side transistor, providing the input voltage to the switch node based on a high-side driving signal;
a low-side transistor, coupling the switch node to the ground based on a low-side driving signal; and
a control circuit, generating the high-side driving signal and the low-side driving signal in each switching period based on a resonant current flowing through the resonant capacitor and the output voltage;
wherein each switching period comprises the following periods:
in a first driving period, the control circuit turns on the high-side transistor and turns off the low-side transistor;
in a second driving period after the first driving period, the control circuit turns off the high-side transistor and turns on the low-side transistor;
in a third driving period after the second driving period, the control circuit turns on the high-side transistor and turns off the low-side transistor;
in a fourth driving period after the third driving period, the control circuit turns off the high-side transistor and turns on the low-side transistor; and
in a fifth driving period after the fourth driving period, the control circuit turns off both the high-side transistor and the low-side transistor;
wherein in response to the resonant current dropping to zero in the second driving period and a predetermined period having elapsed, the control circuit turns off the low-side transistor.

2. The resonant power conversion circuit as claimed in claim 1, wherein when the fifth driving period of one switching period ends, the control circuit immediately executes the first driving period of another switching period;
wherein a first dead time is between the first driving period and the second driving period;
wherein a second dead time is between the second driving period and the third driving period;
wherein a third dead time is between the third driving period and the fourth driving period.

3. The resonant power conversion circuit as claimed in claim 1, further comprising:
a current detection circuit, detecting the resonant current to generate a current detection signal; and
a feedback circuit, generating a feedback signal based on the output voltage;
wherein the control circuit superimposes the current detection signal to a slope compensation signal to generate a superposition signal and integrates the superposition signal to generate a first integral signal;
wherein the control circuit further full-wave rectifies the first integral signal to generate a full-wave rectification signal;
wherein the control circuit integrates the feedback signal to generate a second integral signal and compares the full-wave rectification signal with the second integral signal to generate the high-side driving signal and the low-side driving signal.

4. The resonant power conversion circuit as claimed in claim 3, wherein in response to the full-wave rectification signal dropping to not exceeding the second integral signal during the first driving period, the control circuit turns off the high-side transistor;
wherein in response to the full-wave rectification signal dropping to not exceeding the second integral signal during the third driving period, the control circuit turns off the high-side transistor.

5. The resonant power conversion circuit as claimed in claim 3, wherein in response to the current detection signal dropping to zero during the second driving period and the predetermined period having elapsed, the control circuit turns off the low-side transistor.

6. The resonant power conversion circuit as claimed in claim 3, wherein in response to the current detection signal dropping to zero during the fourth driving period, the control circuit turns off the low-side transistor.

7. The resonant power conversion circuit as claimed in claim 1, wherein a resonant period is determined by the resonant capacitor;
wherein the predetermined period is less than one-half of the resonant period.

8. The resonant power conversion circuit as claimed in claim 1, wherein a length of the fifth driving period is a fixed value.

9. The resonant power conversion circuit as claimed in claim 1, wherein a length of the fifth driving period is determined by output power of the output voltage;
wherein when the output power decreases, the length of the fifth driving period increases;
wherein when the output power increases, the length of the fifth driving period decreases.

10. A resonant power conversion circuit for converting an input voltage to an output voltage, comprising:
a transformer, comprising a primary coil and a secondary coil, wherein the primary coil is coupled between a switch node and a resonant node;
a resonant capacitor, coupled between the resonant node and a ground;
a high-side transistor, providing the input voltage to the switch node based on a high-side driving signal;
a low-side transistor, coupling the switch node to the ground based on a low-side driving signal; and
a control circuit, generating the high-side driving signal and the low-side driving signal in each switching period based on a resonant current flowing through the resonant capacitor and the output voltage;
wherein each switching period comprises the following periods:
in a first driving period, the control circuit turns off the high-side transistor and turns on the low-side transistor;
in a second driving period after the first driving period, the control circuit turns on the high-side transistor and turns off the low-side transistor; and
in a third driving period after the second driving period, the control circuit turns off the high-side transistor and turns on the low-side transistor;
wherein a length of the first driving period is a fixed value, so that the high-side transistor is turned on under zero-voltage switching during the second driving period to reduce a frequency for driving the resonant power conversion circuit.

11. The resonant power conversion circuit as claimed in claim 10, wherein the fixed value is less than one-half of a resonant period;
wherein the resonant period is determined by the resonant capacitor.

12. The resonant power conversion circuit as claimed in claim 10, wherein when the third driving period of one switching period ends, the control circuit immediately executes the first driving period of another switching period;
wherein a first dead time is between the first driving period and the second driving period.

13. The resonant power conversion circuit as claimed in claim 10, wherein each switching period comprises a fourth driving period;
wherein the fourth driving period is between the second driving period and the third driving period;
wherein the control circuit turns off the high-side transistor and turns on the low-side transistor during the fourth driving period;
wherein a second dead time is between the second driving period and the fourth driving period.

14. The resonant power conversion circuit as claimed in claim 13, further comprising:
a current detection circuit, detecting the resonant current to generate a current detection signal; and
a feedback circuit, generating a feedback signal based on the output voltage;
wherein the control circuit superimposes the current detection signal to a slope compensation signal to generate a superposition signal and integrates the superposition signal to generate a first integral signal;
wherein the control circuit further full-wave rectifies the first integral signal to generate a full-wave rectification signal;
wherein the control circuit integrates the feedback signal to generate a second integral signal and compares the full-wave rectification signal with the second integral signal to generate the high-side driving signal and the low-side driving signal.

15. The resonant power conversion circuit as claimed in claim 14, wherein in response to the full-wave rectification signal dropping to not exceeding the second integral signal during the second driving period, the control circuit turns off the high-side transistor;
wherein in response to the current detection signal dropping to zero during the fourth driving period, the control circuit turns off the low-side transistor.

16. The resonant power conversion circuit as claimed in claim 10, wherein a length of the third driving period is a fixed value.

17. The resonant power conversion circuit as claimed in claim 10, wherein a length of the third driving period is determined by output power of the output voltage;
wherein when the output power of the output voltage decreases, the length of the third driving period increases;
wherein when the output power of the output voltage increases, the length of the third driving period decreases.

18. A resonant power conversion circuit for converting an input voltage to an output voltage, comprising:
a transformer, comprising a primary coil and a secondary coil, wherein the primary coil is coupled between a switch node and a resonant node;
a resonant capacitor, coupled between the resonant node and a ground;
a high-side transistor, providing the input voltage to the switch node based on a high-side driving signal;
a low-side transistor, coupling the switch node to the ground based on a low-side driving signal; and
a control circuit, generating the high-side driving signal and the low-side driving signal in each switching period based on a resonant current flowing through the resonant capacitor and the output voltage;
wherein each switching period comprises the following periods:
in a first driving period, the control circuit turns off the high-side transistor and turns on the low-side transistor;
in a second driving period after the first driving period, the control circuit turns on the high-side transistor and turns off the low-side transistor;
in a third driving period after the second driving period, the control circuit turns off the high-side transistor and turns on the low-side transistor;
in a fourth driving period after the third driving period, the control circuit turns on the high-side transistor and turns off the low-side transistor; and
in a fifth driving period after the fourth driving period, the control circuit turns off both the high-side transistor and the low-side transistor;
wherein a length of the first driving period is a first fixed value;
wherein the first fixed value is less than one-half of a resonant period;
wherein the resonant period is determined by the resonant capacitor.

19. The resonant power conversion circuit as claimed in claim 18, wherein when the fifth driving period of one switching period ends, the control circuit immediately executes the first driving period of another switching period;
wherein a first dead time is between the first driving period and the second driving period;
wherein a second dead time is between the second driving period and the third driving period;
wherein a third dead time is between the third driving period and the fourth driving period.

20. The resonant power conversion circuit as claimed in claim 18, further comprising:
a current detection circuit, detecting the resonant current to generate a current detection signal; and
a feedback circuit, generating a feedback signal based on the output voltage;
wherein the control circuit superimposes the current detection signal to a slope compensation signal to generate a superposition signal and integrates the superposition signal to generate a first integral signal;
wherein the control circuit further full-wave rectifies the first integral signal to generate a full-wave rectification signal;
wherein the control circuit integrates the feedback signal to generate a second integral signal and compares the full-wave rectification signal with the second integral signal to generate the high-side driving signal and the low-side driving signal.

21. The resonant power conversion circuit as claimed in claim 20, wherein in response to the full-wave rectification signal dropping to not exceeding the second integral signal during the second driving period, the control circuit turns off the high-side transistor;
wherein in response to the full-wave rectification signal dropping to not exceeding the second integral signal during the fourth driving period, the control circuit turns off the high-side transistor.

22. The resonant power conversion circuit as claimed in claim 20, wherein in response to the current detection signal dropping to zero during the third driving period and a predetermined period having elapsed, the control circuit turns off the low-side transistor;
wherein the predetermined period is less than one-half of the resonant period.

23. The resonant power conversion circuit as claimed in claim 18, wherein a length of the fifth driving period is a second fixed value.

24. The resonant power conversion circuit as claimed in claim 18, wherein a length of the fifth driving period is determined by output power of the output voltage;
wherein when the output power decreases, the length of the fifth driving period increases;
wherein when the output power increases, the length of the fifth driving period decreases.
